(19) United States
(12) Patent Application Publication
(10) Pub. No.: US 2012/0229270 A1
(43) Pub. Date: Sep. 13, 2012

(54) Wearable biofeedback system

(76) Inventors: Christopher Morley, Denver, CO (US); Neil D. Blank, Eldorado Springs, CO (US)

(21) Appl. No.: 12/932,936

(22) Filed: Mar. 11, 2011

(51) Int. Cl. G08B 1/08

(52) U.S. Cl. 340/539.12

(57) ABSTRACT

A wearable biofeedback device is provided. The device preferably includes a glove structure and external display device. The glove has at least one sheath for receiving a digit. The glove and sheath include dorsal and palmer surfaces. The palmer surfaces include at least one sensor for acquiring a bio-signal. The dorsal surface includes a compartment for containing an electronics control module. The electronics module is contained in the compartment, and is in communication with the sensor. A circuit system, accommodated in the electronics module, includes an analog to digital converter, a processor for performing an analysis and translation of the digitized bio-signals into a biometric measurement data, a battery, and a wirelessly transmission module for performing wirelessly transmission to the external device. The external device is wirelessly communicated with the glove through the wireless transmission module, and is adapted to display the biometric measurement data in an audio or visual display.

### CROSS REFERENCE TO RELATED APPLICATIONS

None.

### STATEMENT OF FEDERALLY SPONSORED RESEARCH

Not Applicable.

### BACKGROUND OF THE INVENTION

1. Field of the Invention

The present invention relates to biofeedback computer systems. In particular, it relates to a wearable real-time biofeedback computer system for wireless connection and display of one's physical health condition.

2. Description of the Related Art

Biometric feedback data is used by individuals, coaches, therapists or other medical specialists to analyze and aid individuals in controlling or modifying their responses to certain stimulus or events. Biometric measurements, as affected by typical daily stimulus of the user, allow the user, clinician, coach, therapist, user groups, or other associated professionals the insight into a person's reactions to these stimulus events.

The use of biometric feedback devices is well known. Such devices generally include personal data processors, such as desktop computers, which are generally large and complicated systems confining the user in a bundle of cables and connections which restrict the users' movements and activities. These restrictions also act to diminish much of the desired biometric measurements, and the resultant data collected. Moreover, when operable with a desktop computer, any feedback information generated during an individuals' day-to-day activities, where stimulus events can significantly affect biometrics, is not available to the user for analysis while performing. Thus, examples of certain portable biofeedback systems have been disclosed which are directed toward the use of a more portable display device.

One such example is disclosed in U.S. Pat. No. 7,613,510 to Rentea et al. There a biofeedback device displaying results on a cellular phone display is disclosed. The biofeedback information is measured at a body part of a user with a device, such as a cell phone or stand alone pen communicating wirelessly with a cell phone. The device, such as one for measuring electrical parameters of the skin, produces a biofeedback signal, which is an electrical signal indicative of biological activity or information.

Another such example, disclosed in U.S. Pat. No. 7,785,249 to Schacter et al., discloses a method and apparatus for relieving stress using biofeedback techniques. This method and system are used according to a specified regimen to enable a user to achieve a relaxed state. The apparatus includes a sensor wirelessly connected to a CPU which processes signals from the sensor to produce a visual and/or auditory display that is representative of the relaxation state of the user.

While the foregoing methods and materials are useful in providing biofeedback information for use by an individual in correcting a response to an external stimuli, a problem still exists in resolving a need to provide real time biometric measurements obtained from sensors that are easily worn, non-invasive, and non-obtrusive. Moreover, a need exists to provide a wearable device where the sensors and the external display device are co-located with the user so that the user is free to perform his/her normal daily activities without restricting the users' freedom of movement and daily activities. It is yet another need to provide the users with real time graphical, audio, and numerical display representations of their biometric data information during their normal day-to-day activities. The present invention satisfies these needs.

### BRIEF SUMMARY OF THE INVENTION

It is therefore an object of the present invention to provide a wearable biometric device which acquires, processes, and transmits biometric measurement data obtained from physiological, temperature, and optical sensors in a real time display, but which is easily worn, non-invasive, and non-obtrusive.

It is another object of the present invention to provide a wearable device where the biometric sensors and the external device display, including video graphic and multi-media, are co-located with the user so that the user is free to perform his or her normal daily activity habits without restricting the users' movements, so that a useful biometric feedback information is generated as a result of these activities.

It is yet another object of the present invention to wirelessly provide the users with real time graphical, audio, and numerical display representations of their biometric data via an authenticated secure or social network.

To overcome problems associated with the prior art, and in accordance with the purpose(s) of the present invention, briefly, a wearable biofeedback device is provided. The device preferably includes a glove structure and external display device. The glove has at least one sheath for receiving at least one digit. The glove and sheath include dorsal and palmer surfaces. The palmer surfaces including at least one sensor for acquiring a bio-signal, and the dorsal surface includes a compartment for containing an electronics control module. The electronics module is contained in the compartment and is in communication with the sensor. A circuit system, accommodated in the electronics module, includes an analog to digital converter for receiving and digitizing the bio-signals acquired by the sensor, a processor for performing an analysis and translation of the digitized bio-signals into a biometric measurement data, a battery for providing power, and a wirelessly transmission module for performing wirelessly transmission to the external device which is wirelessly communicated with the glove through the wireless transmission module and is adapted to display the biometric measurement data in an audio or visual manner.

Additional advantages of the present invention will be set forth in the description that follows, and in part will be obvious from that description or can be learned or appreciated from practice of the invention. Moreover, the advantages of the invention can be realized and obtained by the invention as more particularly pointed out in the appended claims.

### BRIEF DESCRIPTION OF THE SEVERAL VIEWS OF THE DRAWINGS

The accompanying drawings, which are incorporated in and which constitute a part of the specification, illustrate at least one embodiment of the invention and, together with the description, explain the principles of the invention through illustration to persons of skill in the art.

FIG. 1 is an isometric view showing the preferred embodiment of the glove wearable device when positioned on the hand and in use with a personal digital assistant.

FIG. 2 is an isometric view showing the preferred embodiment of the dorsal portion of the glove together with the compartment, the electronics module, and conductive strips of the circuit system.

FIG. 3 is an isometric view showing the preferred embodiment of the dorsal portion of the glove together with the compartment, the electronics module, and conductive strips of the circuit system.

FIG. 4 is an isometric view of the pressure sensor sandwiched between the biometric sensor and membrane of the glove.

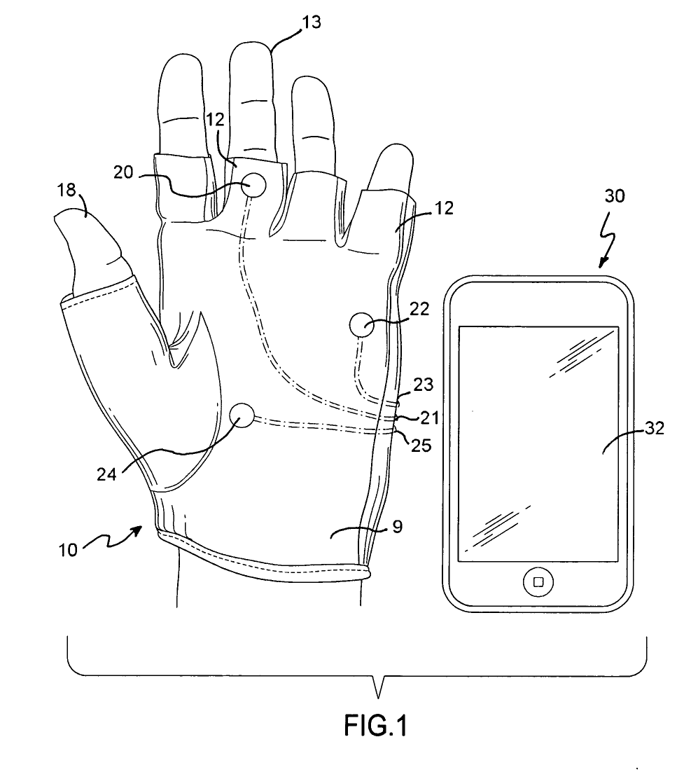

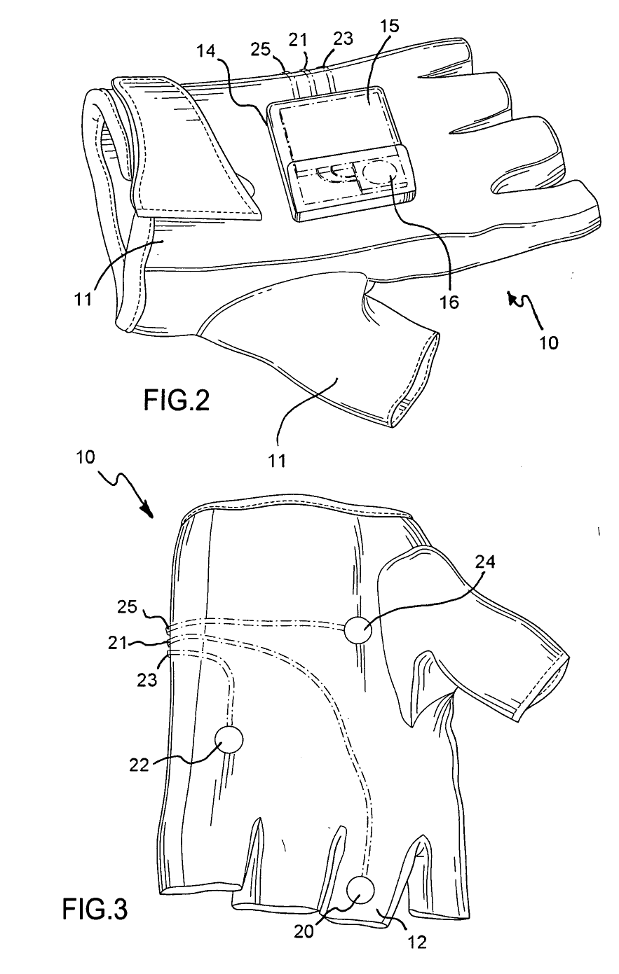

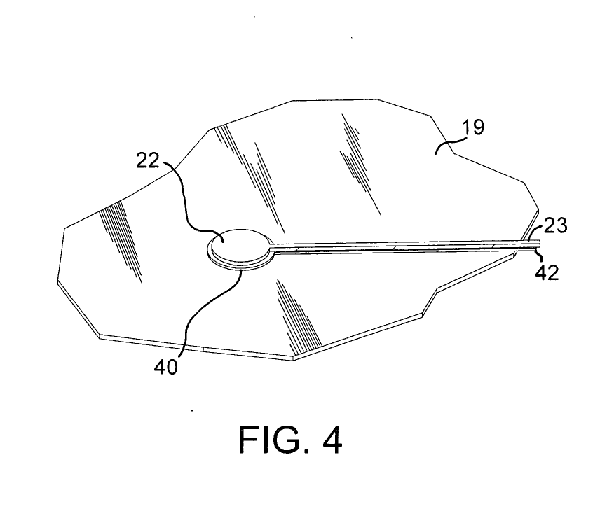

### DETAILED DESCRIPTION OF THE INVENTION

Unless specifically defined otherwise, all scientific and technical terms, used herein, have the same ordinary meaning as would be commonly understood by one of ordinary skill in the art to which this invention belongs.

Although any methods and materials similar or equivalent to those described herein, can be used in the practice or testing of the present invention, the preferred methods and materials are now described. Reference will now be made in detail, to the presently preferred embodiments of the invention, including the examples of which are illustrated in the accompanying drawings. In the drawings, like numerals will be used in order to represent like features of the present invention.

The present invention provides users with immediate graphical, audio, and numerical representation of their biometric information without restricting users from their normal day-to-day activities. Biometric measurements include, but not by way of limitation, galvanic skin response, skin temperature, heart rate, and blood oxygen levels. In use, the present invention provides one with the ability to process multiple biometric measurements through a set of computer software algorithms that correlate the various measurements so that the user is subject to a much improved evaluation of his or her response to physical and emotional situations.

The biometric measurements are acquired from sensors, in real-time, that are easily worn, non-invasive, and non-obtrusive. A typical group of sensors are integrated into the wearable measurement collection device. The wearable measurement collection device, sometimes referred to as a WMCD, is desirably constructed as a glove structure which is worn on the hand. However other means of wearable connection of the sensors to a part of the body are also contemplated herein. The glove also contains and electronics module to wirelessly transmit in real time the digital representations of the sensor outputs via analog measurement circuits, analog to digital conversion, and packaging into a data stream using a predetermined protocol.

A substantially immediate interpretation or storage of the biometric measurements is facilitated by a mobile computing external device that is connected wirelessly, or optionally via a wire connection, to the electronics module. The sensors and the mobile computing device are easily co-located so that the user is freely able to move about in the performance of his daily activities. The external device may include applications for the computational analysis of the sensor output digitized data as well as providing the various forms of interpreted output for the user.

The invention further allows users to share biometric information through various means such as wirelessly, cellular, internet, other individuals, groups, social networks, and/or therapeutic service providers. The biometric information displayed on the mobile device is useful in altering the outcomes of physical training, self improvement, and behavioral modification.

As noted above, a hand wearable biofeedback device is provided. With the preferred embodiment, as illustrated in the drawing figures, the device includes a glove 10 structure and external display device 30. The glove 10 has at least one sheath 12 for receiving at least one digit 13. The glove 10 and sheath 12 include dorsal 11 and palmer 9 surfaces. The palmer surfaces including at least one sensor 20 for acquiring a bio-signals, and the dorsal surface 11 includes a compartment 14 for containing an electronics control module 15. The electronics module 15 is contained in the compartment 14 and is in communication with the sensor 20. A circuit system, accommodated in the electronics module 15, includes an analog to digital converter for receiving and digitizing the bio-signals acquired by the sensor, a processor for performing an analysis and translation of the digitized bio-signals into a biometric measurement data, a battery 16 for providing power, and a wirelessly transmission module for performing wirelessly transmission to the external device 30 which is wirelessly communicated with the glove 10 through the wireless transmission module and is adapted to display the biometric measurement data in an audio or visual manner.

The glove 10 and external device 30 operate through a wirelessly remote communication, in conjunction with one another, to form the basic components of the present invention. In its preferred embodiment, the glove 10 is fingerless, includes openings and sheaths 12 for receiving the digits 13, of the hand, and the glove 10 and sheaths 12 include dorsal 11 and palmer 9 surfaces. In a first embodiment, illustrated in the drawing figures, the glove includes a heart rate sensor 20 positioned for contact with the palmer surface of the proximal phalanges of the middle, or ring, finger 13. The heart rate sensor 20 is in electrical communication with the electronics module with a flexible conductive strip 21 as a component of the circuit system. The heart rate sensor 20 is desirably an optical sensor, such as any pulse oxmieter, well known in the art, which illuminates the skin and measures changes in light absorption of the perfusion of blood to the dermis and subcutaneous tissue of the skin. The data acquired from such optical sensor is often compiled as a photoplethysmograph (“PPG”). However, while such pulse oximeters are a commonly used medical device, the PPG derived from them is rarely displayed, and is, as with the present invention, nominally only processed to determine and display heart rate. However, it is contemplated that the pulse oximeter sensor, in accordance with the present invention, would measures both the pulse rate and the level of oxygenation in the blood for display.

For example, as the user experiences a change in an environmental stimuli, the concomitant change in blood volume caused by the pressure pulse is detected by the sensor 20 in illuminating the skin with light from a light-emitting diode (LED) of the sensor 20 and then processed to measure the amount of light either transmitted or reflected to a photo diode of the sensor 20 Each cardiac cycle is thus acquired as a peak, in variable changes in photoplethysmograph (PPG) data, and the data is continuously or intermittently wirelessly communicated to the external device 30 for audio or visual display 32 as a heart rate. Moreover, because blood flow to the skin can be modulated by multiple other physiological systems, including those monitored with the other sensors, such as the electro-dermal response (“EDR”) sensors 22, 24 of the present invention, together with the data processing algorithms relative thereto, the PPG result can also be used to monitor breathing and other circulatory conditions which may be wirelessly transmitted to the external device 30 for visual or audio display 32.

In another embodiment of the present invention, it is also desirably to attach to the palmer surface 9 of the glove 10 a pair of pressure sensitive electro dermal response (“EDR”) sensors 22, 24 for measuring skin conductance. As above, the EDR sensors 22, 24 are in electrical communication with the electronics module with flexible conductive strips 23, 25 as a further component of the circuit system. The EDR sensors 22, 24 may be of any type, well known in the art, but, in accordance with the present invention, it is desirable to include the pair of electrical sensor contacts, as shown in the drawings figures. In this manner, the EDR sensors 22, 24 generate a galvanic skin response as a measure the electrical resistance between the two points on the hand where the first 22 and second 24 EDR sensors are positioned. The contacts also desirably include a mounting membrane and the conducting trace or wire for the EDR sensor to communicate with the electronics module 15. The electrodes are preferably electrically conductive, at least in part. The first sensor 22 electrode and second sensor 24 electrodes includes a large flat skin-contacting surface portion which directly engages the palm of the users' hand. The relative positioning and location of the EDR sensors may be varied, also. However, in the illustrated embodiment the first sensor 22 electrode is positioned adjacent to the distal portion of the little finger 17 metacarpal whereas it articulates the proximal phalanges of the little finger 17, and whereas the second sensor 24 electrode is positioned adjacent the metacarpal of the thumb 18.

The EDR sensors 22, 24 themselves are desirably an alloy or chemical compound of a silver-silver chloride plated metallic disk or button in the skin-contacting portion. Other combinations of alloy or chemical compounds may be used, as well, including an aluminum electrode and a silver chloride electrode, or where the first electrode is copper or brass or other cuprous metal, in combination with a second or aluminum electrode. Alternately, the sensor electrode may be deposited as a metallic layer adhered to the palmer portion of the glove as an alloy or chemical compound film. The film may be formed using a foil, such as aluminum, adhered to the glove substrate, or may be formed by depositing the film using chemical vapor deposition or sputtering processes. In another embodiment, the first sensor 22 and the second sensor 24 electrodes may be combined as an electrode set in accordance with any combination which is well known in the art. The EDR sensors 22, 24 make direct contact with the palmer surface of the user's hand.

In the preferred embodiment, the EDR sensors 22, 24 are in a stacked alignment adjacent a pressure sensor 40. The pressure sensor 40 also includes accompanying electrical connections, such as a conductive strip, or wire, 42 for electrical communication with the electronics module 15. The pressure sensor 40 and accompanying electrical connections are sandwiched and adhere between the EDR sensor 22 and the glove backing membrane 19. In this manner, the pressure sensor 22 is in communication with the electronics module 15 so that artifacts, or signal noise, in the electrical current signal generated with the EDR sensor, while the user is moving in his or her day-to-day activities, is filtered, buffered, cancelled, amplified, or attenuated so that the signal demonstrates a high degree of fidelity for processing and display. The attenuation of artifacts in the signal is accommodated in the circuit system of the electronics module which is programmed with software algorithms which process the pressure sensor 40 acquired pressure data, the EDR acquired conductive data, and output a GSR data which is capable of a high degree of precision, through the attenuation of the artifacts resulting from pressure on the EDR sensors 22, 24 In use, this sandwiched configuration in combining the position of the biometric sensor to the pressure sensor 40 is useful to concurrently measure biometric data and data relative to the pressure applied to the biometric sensor. Processing these data streams allows for the correction of biometric measurement due to variations caused by pressure or movement of the biometric sensor.

Another use is a configuration where one biometric sensor is paired with more than one pressure sensors and configured as an array. With the array configuration, measurements can be made as above, but may also be processed in combination with the pressure data acquired from the additional pressure sensors. The use of a plurality of pressure sensors also allows information to be calculated on the orientation of the biometric sensor. This information is useful in making the calibration alignment and correction of the biometric measurement data. This configuration further allows for large amounts of signal data to be generated from a plurality of the pressure sensors when spread over a larger area of the glove. Overall, this processing on individual “points” of pressure, such as acupuncture points, together with the corresponding biometric measurements allows for a determination of the local effects and statistically corrected measurements which aids is precision.

The electrical feedback from the EDR biometric sensors 22, 24 is made in combination with the electrical feedback from the pressure sensors 40. The respective currents, voltages, and frequencies are measured via an analog interface located at the sensor or electronics module. Signal integrity is maximized via amplification in a linear and a logarithmic manner, offset-nulling, common mode and single ended noise reduction filtering, and with certain other mathematical operations. Isolation circuitry is also provided in a predetermined manner depending on the intended use.

The pressure sensor configurations may be variably configured. For example, the sensors may be configured in an Analog Sensor Interface Block. Here, this block of circuitry supplies power, voltages and references needed by the biometric and pressure sensors. Signals from the sensors are buffered (A/D buffering), amplified, and filtered. Amplitude is shifted, integrated, differentiated and otherwise manipulated to create signals for the A/D block. This block also supplies a feedback path for analog manipulation of the biometric and pressure signals.

In another configuration an analog to digital block is provided. The primary function of this block is to digitize analog signals provided from the Analog Sensor Interface Block. Signals will be digitized with number of bits and sampling rates significantly high enough to provide abundant data for a processing block. Oversampling, digital filtering, gain and phase shift, and offset correction functions may be processed at this stage.

In another configuration, the Processing Block of the signal path includes a digital signal processing (“DSP”) function and sensor specific calibration and transducer correction functions.

In yet another configuration, a Signal Integrity block is provided where the digital signals form the A/D block are further processed to optimize signals prior to the pressure correction block.

Another example includes yet another configuration where the Pressure Correction Block is provided. This block is mainly implemented in the processor where pressure measurements and biometric measurements are combined to create a pressure corrected biometric measurement. In the previous blocks, Analog Sensor Interface and A/D/Buffering, some interaction of pressure sensor and biometric sensors may be used to enhance signal integrity, whereas the primary function of this block is the pressure correction of signals or measurements from the biometric sensor and pressure sensors.

This block contains digital signal processing functions as well as curve fitting of biometric sensor response and the related change in pressure between the body (subject) and pressure sensor. Biometric response curves may be based on manufacturer's guidelines or may be empirically determined by individual sample tests.

In some cases the sensor may be calibrated to the specific user by invoking “Cal” processes where the user applies pressure while the invention measures changes in biometric and pressure response. This information is used to aid the pressure correction block in the process of biometric data correction for a specific user.

Moreover, it is desirable to include a Valid Data Determination loop. In addition to curve-fitting or correction of biometric data based on pressure, this block of the invention will determine if biometric data is out of range from possible valid readings. If a biometric measurement periodically exceeds predetermined limits, current data will be determined to be inaccurate or invalid and will be flagged. The determination of invalid data may be based on rates of change, minimum/maximum values, waveform shape, excessive noise or other event not matching limits of physical biometric parameter is measured.

Finally, and in yet another embodiment, it is desirable to include a Final Data, Filtering and Fill loop. Here, upon determination of invalid or inaccurate data, the measurement data stream may be filled by previous values or data trends or left blank depending on the specific biometric measurement and application. Discontinuities in biometric data may be flagged. If data is filled, flag will include information on type and duration of fill for use by downstream processing or application.

The wearable device may, but need not, include other physiological sensors as well. For example in another embodiment the glove includes a thermistor, such as an epoxy filled micro probe sensor, for monitoring surface temperature at the skin. It is also contemplated for use herein the combination of an oxygen sensor with the glove, electronics module and external device.

The present invention includes an electronic module 15 contained in a pocket 14 on the dorsal side 11 of the glove 10. The electronic module 15 includes circuitry for power, data processing and external data communication with the external device. One aspect of the data processing is the inclusion of the analog to digital signal converter for digitizing the analog signals output by bio-signal sensors. The analog signals are processed into digital values by a digital conversion and processing component (“DCP”) and are then further aggregated into a protocol for transmission by the wearable device. Each sensor type is given a unique identification datum, and, together with the recorded data, is formatted into a digital data stream in binary, hex, or other standard, such as XML.

The converted digital signal data is then processed for performing an analysis and translation of the digitized bio-signals into the biometric measurement data ultimately displayed for use in altering one's behavior. In some embodiments, the circuit includes a network interface for wireless connection with a server and network, such as the internet. The network interface may be an analog or digital modem or transceiver circuit for digital data communication. Alternative, and in the preferred embodiment, the network interface is a wirelessly communicating circuit of any suitable type for wireless communication with the external device 30. In this manner, the circuitry for external data communication further includes a wireless interface for wireless communication with the external device.

The electronics module 15 controls operation of the glove 10. The controller, of the module 15, may be implemented as a processor, microprocessor, digital signal processor or any other logic circuit or combination of circuits providing control connections. The controller operates in response to the sensor acquired data and program instruction stored in the memory. In one mode, the controller controls the radio communication circuit by directing the tuning, activation and deactivation of the circuit.

The external device 30 is desirably a mobile phone, a personal digital assistant (“PDA”) or a wrist worn device, tablet, laptop, or desktop computer, and the measurement data are translated into numerical, graphical, and audio outputs on the external device. Such devices are otherwise also known as a mobile, portable, handheld, user equipment, cell phone. Such devices include an antenna, a receiver, a transmitter, a controller, a memory, user interface, and battery. Examples include Bluetooth, IEEE Standard 802.11 (wireless local area network communication in the 2.4, 3.6 and 5 GHz frequency bands) and such related standards for over the air modulation techniques, and cellular and Persona Communication System transceiver circuits.

In the preferred embodiment the external device 30 includes memory, or memory card, which is capable of storing an application program for operating and communicating the input signals from the glove 10, and displaying the measurement data in a user capable format suitable in altering the user's behavior. The external device 30 desirably includes a user interface application. With this embodiment, the user interface of the external device includes hardware such as a keypad or touch sensitive display screen. Where the external device 30 is a cellular telephone the user interface further includes a microphone. In the more preferred embodiment, the user interface includes a display sufficiently large enough to display graphical data, such as a PPG, text and photographs. The user interface accordingly includes one or more software application programs for controlling the biofeedback measuring device in measuring biofeedback signals, processing received data and producing a display based on the data. The software application programs may be configured as computer readably program code and stored in the memory. The battery provides operating power for the external device. The cellular telephone or PDA external devices may be combined for use with other equipment such as a portable computer or printer.

The external device 30 may be of the type which is also referred to as a mobile computing device (“MCD”). In use, this device provides programmability in-so-far as it contains the necessary processing software to read the sensor data, provide comparative analysis, and form outputs easily understood by the user. Different versions of optional components of the operating system for the MCD are variably implemented in accordance with the predetermined objectives of the feedback.

For example, an application software program processes a stream of biometric measurement data acquired via the wireless protocol or a wire connector. A Communications and Protocol Interface software component receives the data stream and prepares the data for the Validate Filter Data software (VFD) component. The VFD software component processes each sensor's data to eliminate erratic peaks, amplify signal readings, and to provide signal averages. This data is then forwarded to the Process and Data Measurement Correlation Algorithms for further processing.

The Process and Data Measurement Correlation Algorithms are specifically programmed to provide interpretation of each sensor's values over time, and to correlate multiple sensors in a manner which provides meaningful results to the user. The Process and Data Measurement Correlation Algorithms together with the User Controls and the Format and Output View Controller form a Model-View-Controller. The user has ultimate control of what sensors are to be displayed and how they are displayed via the User Controls. User Controls are adjusted through a user interface that can take input from keypads, mouse, or ball, movements and clicks, and/or touch inputs. User selections provide the controls necessary to vary the Process and Data Measurement Correlation Algorithms and vary the output forms available in the Format and Output View Controller.

Four output mechanisms can be selected for the Format and Output View Controller. These output mechanisms can be selected individually, together, or as an element of a game. The output forms include: (1) Graphical Output which is a time-based graph is drawn on the display update nominally once per second to show the relative or differential values of each of the sensors; (2) Numerical output—to show the value, updated every several tenths of a second of any one or all of the sensors; (3) Audio output—to produce a tone that varies in pitch or music that caries in volume in response to any one of the sensors' outputs; and Networking output—to produce a time delineated accumulation of sensor outputs; (4) screens, photos, menus,—automated or animated by user biometric Data. The networking output is a desirable feature such that the user is able to select to allow his or her preference to publish the results that have been accumulated to others over a social networking mechanism or via a direct file transfer. The Output View Controller also maintains a historical record of sensor data within the Mobile Computing Device that can be analyzed, re-displayed, and/or transferred at a latter point in time.

While, the present invention has been described in connection with the preferred and illustrated embodiments, it will be appreciated and is understood that certain modifications may be made to the present invention without departing from the true spirit and scope of the invention.

I claim:

1. A wearable biofeedback device for use in monitoring a physiological response while in motion, comprising:
(a) a structure having at least one sheath for receiving at least one digit, the glove and sheath including a dorsal and a palmer surfaces, the palmer surface including at least one sensor for acquiring a bio-signals;
(b) an electronics module in communication with the sensor;
(c) a circuit system, accommodated in the electronics module, including an analog to digital converter for receiving and digitizing the bio-signals acquired by the sensor, a processor for performing an analysis and translation of the digitized bio-signals into a biometric measurement data, a battery for providing power, and a wirelessly transmission module for performing wirelessly transmission, and
(d) an external device wirelessly communicated with the device structure through the wireless transmission module and adapted to display the biometric measurement data.

2. The wearable wireless biofeedback device according to claim 1, wherein the bio-signals are generated and acquired continuously.

3. The wearable wireless biofeedback device according to claim 1, wherein the bio-signals are generated and acquired intermittently.

4. The wearable wireless biofeedback device according to claim 1, wherein the biometric measurement data are used to guide the user to change from a current physiological condition to another physiological condition.

5. The wearable wireless biofeedback device according to claim 1, further comprising a glove backing membrane in the palmer surface.

6. The wearable wireless biofeedback device according to claim 1, wherein the external device is further adapted for storage of the biometric measurement data.

7. The wearable wireless biofeedback device according to claim 1, wherein external device is selected from the group consisting of a mobile phone, a PDA or a wrist worn device, and the measurement data are translated into numerical, graphical, and audio outputs on the external device.

8. The wearable wireless biofeedback device according to claim 1, wherein the external device is adapted for connecting the electronics module to a network.

9. The wearable wireless biofeedback device according to claim 1, wherein the sensor is selected from a group consisting of physiological electrode, temperature sensing element, optically sensing element, or pressure sensing element.

10. The wearable wireless biofeedback device according to claim 1, wherein the circuit system further comprises and authentication circuit adapted for user identification.

11. The wearable wireless biofeedback device according to claim 1, wherein the external device further comprises a user interface application algorithm.

12. The wearable wireless biofeedback device according to claim 1, wherein the electronics module further comprises a compartment and circuit for engaging and communicating with a memory card.

13. The wearable wireless biofeedback device according to claim 1, wherein the structure is a glove.

14. The hand-wearable wireless biofeedback device according to claim 8, wherein the network is the internet.

15. The hand-wearable wireless biofeedback device according to claim 8, wherein the electronic module is connected to the external device through the network.

16. The hand-wearable wireless biofeedback device according to claim 9, wherein the sensor measures an electro dermal response using a pair of electrical contact and a pressure sensor so that the sensors acquire a bio-signal which is substantially free of an artifact.

17. A method for monitoring a biofeedback physiological response while in motion, comprising the steps of:
(a) providing a wearable glove structure having at least one sheath for receiving at least one digit, the glove and sheath including a dorsal and a palmer surfaces, the palmer surface including at least one sensor for acquiring a bio-signals, and a dorsal surface;
(b) providing an electronics module in communication with the sensor;
(c) providing a circuit system, accommodated in the electronics module, including an analog to digital converter for receiving and digitizing the bio-signals acquired by the sensor, a processor for performing an analysis and translation of the digitized bio-signals into a biometric measurement data, a battery for providing power, and a wirelessly transmission module for performing wirelessly transmission;
(d) providing an external device wirelessly communicated with the device structure through the wireless transmission module and adapted to display the biometric measurement data;
(e) sensing an acquired bio-signal with the sensor;
(f) digitizing the bio-signal with the circuit;
(g) processing the bio-signal into the biometric measurement data;
(h) wirelessly transmitting the biometric measurement data to the external device; and
(i) displaying the biometric measurement data on the external device.

18. The method according to claim 17, wherein the dorsal surface includes a compartment and the electronics module is encased in the compartment.

19. The method according to claim 17 wherein the sensor measures an electro dermal response using a pair of electrical contact and at least one pressure sensor so that the sensors acquire a bio-signal, the pressure sensor acquires a pressure signal, and the circuit system analysis and translation of the digitized bio-signal is compared to digitized pressure signal.
